(19) United States
(12) Patent Application Publication
(10) Pub. No.: US 2018/0176197 A1
(43) Pub. Date: Jun. 21, 2018

(54) Dynamic Data Protection System

(71) Applicant: Bank of America Corporation, Charlotte, NC (US)

(72) Inventors: Lisa E. Matthews, Charlotte, NC (US); Manu Kurian, Dallas, TX (US); Paul Roscoe, Treuddyn Flintshire (GB)

(21) Appl. No.: 15/380,785

(22) Filed: Dec. 15, 2016

(51) Int. Cl. H04L 29/06

(52) U.S. Cl. CPC H04L 63/061; H04L 63/0853; H04L 63/1408; H04L 63/10

(57) ABSTRACT

A dynamic data protection system may include a data management server includes a processor and a non-transitory memory device storing instructions that cause the data management server to receive, via a network connection from a user device, a request for access to data stored on an organization's network. The data management server may then communicate user authentication information associated with the received request. The security management server may process user authentication information to determine whether an authentication code associated with the user is valid and associated with the requested data. Upon validation of the user authentication information by the security management server, provide access to data via a secured data container of a data envelope corresponding to the data, wherein the data container corresponds to the validated user authentication information. When a data compromise event occurs, the secure data envelope may prevent unauthorized access to the data.

### FIELD OF THE INVENTION

Various aspects of the disclosure relate to preventing unauthorized access to data. More specifically, aspects of the disclosure relate to managing access to data via a secure data envelope that includes multiple data containers, where each data container is associated with a protected data access tier where, when a data compromise event occurs or upon identifying improper dissemination of data accessed through the data container, the secure data envelope may prevent unauthorized access to the data.

### BACKGROUND OF THE INVENTION

Large computing environments may include many servers that host and/or otherwise support many different applications and store large amounts of data. In many cases, this data may include sensitive or personal information that may be the target of an intrusion event from an outside actor, such as via ransomware, spyware, virus, malware, or other attack vector. While data encryption or passwords alone may be used and may provide some level of protection for the business organization's data, events that compromise system data security may leave data exposed to data hijack, capture, ransomware, or other data such attacks. In some case, unintended characteristics of operating systems installed within a computing environment, such as operating system defects, software application defects, back doors, and the like, may be exploited and/or leveraged to facilitate an intrusion event. In such cases, data accessible via computing systems running a compromised operating system and/or application may be exposed to outside actors. In some cases, data may be compromised, either willingly or unwillingly, by actions of individuals authorized to access at least a portion of the system data. As such, a need has been recognized to improve data security systems and methods utilized by a business organization to protect their data from exposure to unauthorized individuals.

### SUMMARY OF THE INVENTION

Aspects of the disclosure provide effective, efficient, scalable, and convenient technical solutions that address and overcome the technical problems associated with preventing unauthorized access to data. In particular, one or more aspects of the disclosure provide techniques for managing access to data via a secure data envelope that includes multiple data containers, where each data container is associated with one of a plurality of protected data access tiers.

In an internet connected society, business organizations increasingly have been subject to data breaches that may put large amounts of data at risk. As such, businesses and individuals have placed greater emphasis on security of their private and/or non-public data stored in computing systems. When a system is comprised, the persons behind a data breach may have unlimited access to that private and/or non-public data, for example, ransomware, malware, or other such malicious code may be used to secure the data following a data breach event. To minimize a risk of a data breach leaving large amounts of data unprotected and subject to capture and/or unauthorized dissemination, a need has been recognized to protect the data from the inside out, such that an outside force may not be allowed to access and/or damage the data stored within a protected data repository.

In one or more illustrative examples, a dynamic data protection system may include a data management server includes a processor and a non-transitory memory device storing instructions that, when executed by the processor, cause the data management server to receive, via a network connection from a user device, a request for access to data stored on an organization's network. The data management server may then communicate, to a security management server, user authentication information associated with the received request. The security management server may process user authentication information to determine whether the user is authorized and whether an authentication code associated with the user is valid and associated with the requested data. Upon validation of the user authentication information by the security management server, provide access to data via a secured data container of a data envelope corresponding to the data, wherein the data container corresponds to the validated user authentication information.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an illustrative computing environment managing access to data via a secure data envelope that includes one or more data containers according to aspects of this disclosure;

FIG. 2 shows an illustrative event sequence for managing and communicating data via a secure data envelope that includes one or more data containers according to aspects of this disclosure;

FIG. 3 shows an illustrative method for managing access to data via a secure data envelope that includes one or more data containers in accordance according to aspects of this disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

In some cases, an organization may desire to better manage access to information stored and/or used in the business unit's computing system. In some cases, access to the information may be desired to slow or stop access to data upon detection of intrusion from a possible threat vector. To do so, the business organization may desire to use a multi-server, tiered access communication mechanism to manage data access activities. In some cases, a data management server may be configured to provide rotating access to data for some data access events (e.g., viewing data, writing data, and the like). In some cases, the data management server may provide a one-time access to data during data access events, based on the data, permissions to access data, security clearance and the like. The data management server may utilize data access via use of keys, tokens and/or code that may be generated outside the system such that the code cannot be compromised (or minimize the risk of compromise) by an attack vector. Such a configuration may provide greater protection from certain bad actors, such as ransomware, spyware, malware, external unauthorized users, internal unauthorized users, and the like. System compromise continues to leave data exposed to data hijack events, capture events, read events, write events, and/or Ransomware attacks. Additional data compromise events may include leak of data by an insider and/or due to unintentional access. In some cases, the mechanism of managing access to an organization's data may include one or more data containers (e.g., a data envelope) that may be accessed through managed keys or tokens that may be used to securely communicate data and or for “locking down” or securing access to data when a data compromise event is identified.

In some cases, the mechanism may include creating and/or storing a data container including created to provide a controllable container for accessing data. A central device, e.g., a data management server, may register outside devices, in connection to a separate device managing security of the network. Data access may be provided through one or more access levels, each associated with an access tier, including Tier 1 corresponding to extremely sensitive data, Tier 2 corresponding to sensitive data, Tier 3 corresponding to ‘normal’ data, and Tier 4 corresponding to public data. Each data tier requires a separate access key, where each tier may be associated with a ‘family’ of keys corresponding to individual users having access rights to such data. To control access to data, the data management device may selectively activate or deactivate (e.g., lockdown) the controllable data container.

In some cases, a method to access data via the controllable data containers may include, in response to a request to access data, a user may be authenticated and authorized into the system with a base access key (e.g., a zero-layer key and or token), where the controllable data container may give temporary access to data using this base access key to the public Tier 4 data. If a user needs or has permissions to access more sensitive data (e.g., Tier 1-Tier 3 data), the user may request a new key or token to be assigned by the data management. To do so, the data management device and a data security server may authenticate the user using personally identifying information and/or biometric information before assigning a key. If, an unauthorized data access event is detected, the data management device may lock the data container until each user may be re-authenticated by the data security server. In some cases, the data envelope may be associated with an access timer to identify inactivity, a duration of activity or inactivity. In some cases, the data container may be controlled by an authorized individual associated with the organization. The data container may communicate with a trusted user device and if communication is lost and/or a breach is detected, the data container may be locked. Once the unauthorized access activity has ended, the data management server may issue a master re-initiated key once data can be analyzed to confirm no unauthorized data access, data read, data write, and/or data copy activities were identified or if any such activity has ended.

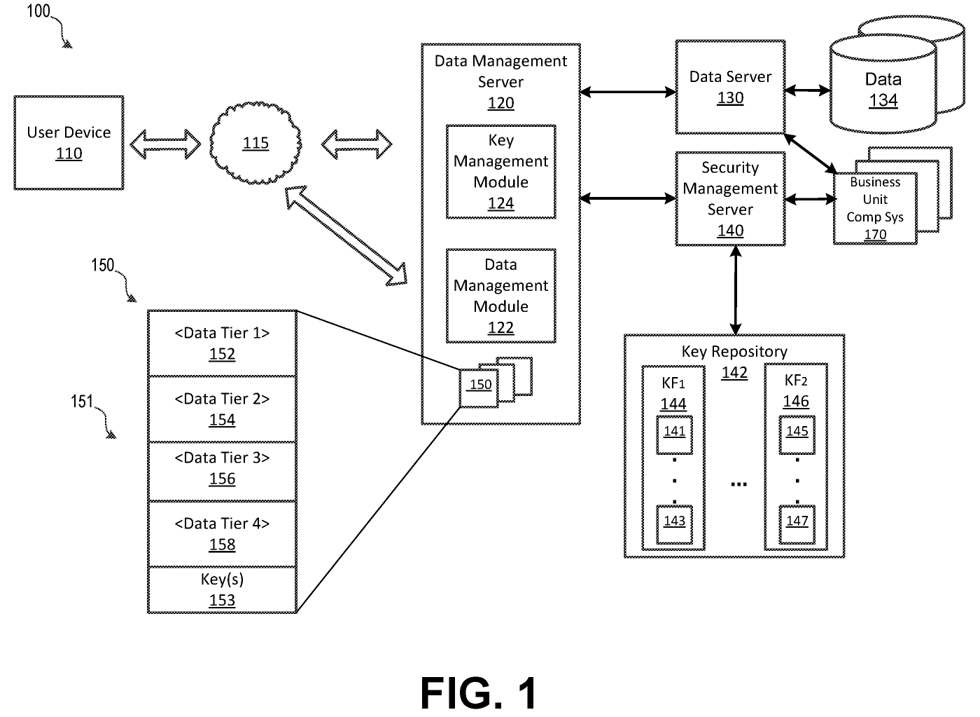

FIG. 1 shows an illustrative computing environment, such as the data access management system 100, managing access to data via a secure data envelope that includes one or more data containers according to aspects of this disclosure. In an illustrative example, the data access management system 100 may include a user device 110 that may be communicatively coupled via a wired or wireless communication link to a network 115 (e.g., the Internet, a telecommunications network, a wide area network (WAN), a local area network (LAN), and the like). The user device 110 may be used to communicate to one or more computing systems, such as those belonging to a business organization, an education institution, a governmental agency, and the like. In an illustrative example, a business organization computing system may include a data management server 120 that may include a key management module 124 and a data management module 122. The data management server may be communicatively coupled to one or more other computing systems of the organization (e.g., business organization, education institution, governmental agency, and the like) and/or third party computing systems. For example, the data management server 120 may be communicatively coupled, either directly or indirectly (e.g., via one or more computing devices such as routers, servers, and the like) to the one or more business unit computing systems 170.

In some cases, the data management server 120 may coordinate communication requests received from the user device 110 along with the data server 130 and the security management server 140. For example, the key management module 124 of the data management server 120 may facilitate user authentication and/or user data access level permission verification with the security management server 140. The security management server 140 may be communicatively coupled to one or more data repositories, such as the key repository 142, and/or business computing systems 170. The key repository 142 may be configured to store a plurality of access keys and/or tokes to manage security. In some cases, a key family (e.g., key family 144, key family 146, and the like) may be associated with different levels of permissions for accessing data. For example, the key family 144 may include a plurality of keys (e.g. key 141, key 143, and the like) which may be used to access a particular first data set and the key family 146 may include a plurality of keys (e.g., key 145, key 147, and the like) may be used to access a particular second data set. In some cases, each key may be associated with a particular user and/or a particular access level accorded that particular user to access the associated data.

In some cases, the data management server 120 may use the data management module 122 to facilitate secure communication of data to and/or from the user device 110, in conjunction with the data security provided by the key management module 124. Once a user has been authorized and/or received proper permissions to access data via the data management server 120, the data management server may generate a data envelope 150 comprising one or more data containers 152, 154, 156, 158 and one or more associated encryption keys 153. The data management server 120 may parse a data request (e.g., a read request and/or a write request) received from the user device 110 to determine whether the requesting device has provided proper security key and, if so, determine an access tier associated with the security key. Based on the authenticated security key, the data management server 120 may request access to data at one or more data repositories 134 and/or at the one or more business unit computing systems 170 based on the permissions associated with the authenticated security key. The data management server may then manage communication of data between the user device 110 and the data repositories using the data envelope 150. In an illustrative example, the data management server 120 may receive a data read request from the user device 110 along with an authenticated security key. If the security key identifies a data tier that allows for access to the desired data, the data management server 120 may request the data form the data repository 134 via the data server. When received the data management server 120 may write the data to the proper data container (e.g., data container 154 for data associated with a second access tier) from which the user device 110 may read the requested data. If the data management server 120 determines that the requested data is not accessible to individuals who provide a particular security code (e.g., a security key associated with a particular access tier), the data management server 120 may return an error (e.g., an access error, a permissions error, and the like) to the user device 110. If, however, the data management server 120 and/or the security management server 140 determine that the provided security key is invalid or may not be used by the proper authorized individual, the security management server 140 may cancel one or more existing security keys associated of the related key family to lock out the particular data repository from access.

In some cases, data communicated via an external network may be contained within a data envelope, such as the data envelope 150. As such, the data may be contained within one or more data containers within the shell, and will not be visible to application that may try to access the data using an operating system application, such as an operating system file explorer, a file viewer, and the like.

In some cases, the data envelope 150 may be generated by and/or managed by a data management server, such as the data management server 120. In an illustrative example, the data management server 120 may initialize and/or create one or more digital containers within the data envelope 150, such as the first data container 152, the second data container 154, the third data container, the fourth data container 158, and the like. In some cases, the data container may include one or more data structures that may include security elements such as a key identifier and/or the like. For example, each of the data containers 151 may correspond to a different access level tier, such as the first data container 152 being associated with a first access level tier (e.g., Tier 1), the second data container 154 being associated with a second access level tier (e.g., Tier 2), the third data container 156 being associated with a third access level tier (e.g., Tier 3), the fourth data container 158 being associated with a fourth access level tier (e.g., Tier 4).

Once the data management server 120 initializes data envelope 150 and the one or more data containers 151 for communication via an authorized communication link to a verified user, the data management server 120 may communicate data via the data container associated with the authorized data access tier associated with the user. In some cases, the data envelope 150 may be a digital container on a server remote from the user device 110, such as the data management server 150. For example, the data management server 150 may be located at a geographical location associated with a business organization data center, at a business organization computing system associated with the data to be communicated, or the like. In some cases, the data envelope 150 may be located on a computing device (e.g., a server) separate from the data management server 120, the data server 130, and/or a computing device associated with the business unit computing systems 170, so that the user may access data at their user device, but would be prevented from being to accessing unauthorized data. For example, if the data communications are locked due to a lockdown event, the user may be prevented from accessing data via the user device.

In some cases, a central server, such as the security management server 140 may be a separate device than the data management server 120 and the data server 130 to separate data access functionality from data security functionality within the organizations computing network. The data management server 120 may facilitate communication of data between one or more devices external to the protected organization computing network and the portions of the organization computing network storing private information. The security management server may maintain one or more lists of data envelopes and associated security keys and/or tokens in a data repository, such as the key repository 142. In some cases, the security management server 140 and/or the key management module 124 may maintain a list of data envelopes. Each of the data envelopes may be associated with one of the one or more different data repositories 134 and/or the one or more business computing systems 170. Each of the data envelopes may be associated with a key or key family. In some cases, a key may be a static key or a rotating key. An example of a static key may be a password, a token value and/or the like. A rotating key may be changeable per use and may be used to provide a one-time access, an expiry time for data access, and the like. In some cases, a previously valid key may be invalidated by the security management server 140 if certain conditions were met or not met. In some cases, the data management server 120 and/or the security management server 140 may detect a compromise or an attempt to compromise the computing system 100. If such a compromise or attempt to compromise is identified, the security management server and/or the key management module 124 may invalidate all keys, all keys associated with a particular data envelope, all keys associated with a data repository 134 or business computing system 170 or the like. In some cases, such an invalidation event may cause all current users to be removed from the data envelope 150. In some cases, following an intrusion event, at least a portion of the users already accessing data via the data envelope 150 may be permitted to continue data access via the data envelope 150 until normal expiry of their key. Once a key or key family has been invalidated, associated users must be re-authenticated. In some cases, a key may be associated with a particular network location, geographic location, device, terminal, access method, and/or the like. In some cases, keys may be time limited (e.g., a daily key, an hour key, and the like), and/or limited to a specified number of access uses (e.g., a one-time key, a two-use key, and the like.).

In some cases, the key (e.g., key 141, 143, 145, 147, and the like) may be issued in one or more formats, such as an alphanumeric value, a biometric key, and/or a combination of such information. In an illustrative example, a key may be generated based on biometric information from a particular user. For example, the biometric information (e.g., a fingerprint, an iris scan, a voice pattern, and/or the like) may be used as an initial authentication of the user to issue a token. The same or different biometric information may be used to create a first key 141 or token for that particular user. Another user may be given the second key 143 based on their biometric information. A hash value that may be used by the security management server 140 may be generated based on multiple factors including biometric information, a time stamp, an identifier of a user device (e.g., a MAC ID and the like), geographic location information associated with a user (e.g., a residence location and the like), and/or other such information.

In some cases, such as when an unauthorized data access attempt is recognized by the data management server 120 and/or the security management server 140, the data management server 120 and/or the security management server 140 may initiate a lockdown procedure. In some cases, a lockdown procedure may include one or more of a forced reboot of the data access management system 100 so that all users are automatically logged out of the system. At such times, user actions may be immediately saved for audit purposes, such that data that may have been accessed by one or more users is versioned to allow for selective restore if improper activity is detected and/or confirmed. In some cases, the data management server 120 and/or the security management server 140 may log users out of a particular data envelope 150 upon which an attempt at an unauthorized access event was identified. In some cases, the data management server 120 and/or the security management server 140 may allow users that are currently logged into the data envelope 150 to remain, but may prevent new users from being logged into the system.

In an illustrative example, a request to access data may be received from the user device 110 via the network 115 by the data management server 120. The data request may include a request to access specific data (e.g., information associated with an account, and the like), a request to access information saved at a particular location (e.g., information stored on a data repository 134), a request to access information associated with one or more associated computing systems (e.g., one or more of the business unit computing systems 170 and the like), and/or other similar data requests. In some cases, a user may request data via a particular data envelope, such as the data envelope 150 known by the user to be associated with the information the user desires to access. The data management server 120 may coordinate with multiple other computing devices to provide a secure separation of external users from data stored on the organization's network. For example, upon a receipt of a data access request from a user, the data management server 120, the key management module 124 may identify whether or not an authorization key or token was included with the data access request and pass that information to a separate device, such as the security management server 140, for processing. The security management server 140 may process any received authorization information, including a lack of user authentication information, using information stored in the key repository 142. In some cases, the security management server may compare the received authentication key to a key (e.g., key 141) from key family 144 when the user is requesting access to information stored in a first data repository 134 or to a key (e.g., key 145) from key family 146 when the user is requesting access to information associated with one or more of the business unit computing systems 170. For example, a user may request user identification information (e.g., user profile information and the like) from the data repository 134 and/or account information (e.g., financial account information, insurance account information, and the like) from a business unit computing system associated with a business unit at which the user has an account, or wishes to apply for an account. The security management server 140 returns an authenticated key and/or approval of a key received from the user, only if the user can be properly authenticated, such as by using the alphanumeric code and/or biometric information.

In some cases, the data management server 120 may configure the data envelope 150 for tiered access using a tiered security model. For example, the first data container 152 may be associated with a first data access tier level 1 (e.g., highest level access permissions), the second data container 154 may be associated with a second data access tier level 2 (e.g., medium-high level access permissions), the third data container 156 may be associated with a third data access tier level 3 (e.g., medium-low level access permissions), the fourth data container 158 may be associated with a fourth data access tier level 4 (e.g., lowest level access permissions). In some cases, a data management server may create a fifth data container, or a different data envelope, that may be associated with a null data set to which an attacker or unauthorized user may be directed to limit their ability to access or repeatedly send messages to the data management server 120. By having multiple types of data within the data envelope 150, a user device may be limited to only access information for which the user is authorized to do so, based on the access tier associated with a particular key 141. In some cases, a user may request a higher access tier, having greater permissions to access data, based on an authentication process performed by the data management server 120 and/or the security management server 140. For example, a first user may be able to access tier 4 data based on the first user's biometric data and/or entitlements (e.g., security clearance, department, job responsibilities, account holdings, and the like). In some case, a second user may have access to tier 2 data based on the second user's biometric data and/or entitlements. In some cases, the data management server 120 and/or the security management server 140 may associate each user, before authentication, at a baseline data access tier, such as data tier 4, such that every user may access publically available information that may be accessible via a particular data envelope via an issued public access token to an authenticated user.

In some cases, when authenticated, the user device 110 may be considered to be a trusted device (e.g., a “trusted station”) upon proper authentication of the user associated with the device. Communication with a trusted station may cause the data management server 120 to ensure that the data envelope 150 (e.g. an access key structure 153, and the like) maintains contact with the security management server 140 via the key management module 124. In some cases, the key management module 124 and/or security management server 140 may poll, or otherwise monitor the access keys at the data envelope 150 at regular intervals (e.g., a number of seconds, a number of minutes, hourly, and the like). In some cases, the key management module 124 and/or security management server 140 may poll, or otherwise monitor the access keys at the data envelope 150 at irregular intervals so that polling interval is not predictable. If the data envelope 150 cannot be accessed or polled by the key management module 124 and/or security management server 140 (e.g., a single failed cycle, multiple failed cycles, over a duration of time, and the like), the data envelope may be disconnected from its associated data repository 134 and/or the user device 110. In an illustrative example, the data management server 120 may communicate to data store 134 via a data server 130. via a cloud connection. However, if the data management server 120 cannot access the data server and/or the data repository 134, the data management server 120 may identify this lack of communication to be associated with a “bad actor” or other individual attempting unauthorized access to the information of data repository 134. As such, the data management server 120 may disconnect from the data repository 134 and/or the data server 130. In some cases, the data management server 120 may utilize keystroke logging and/or may monitor for keystroke logging events while communicating with different users to identify whether multiple individuals may be using a same or similar keystroke pattern, particularly if these different users located in geographically distinct locations (e.g., country A, state B, town C, and the like).

In some cases, the data management server 130 may change a location at which data (e.g., the data envelope 150) is stored on a computing device. In doing so, the data management server 150 may prevent an individual with intent to improperly access data at a known compromised location and/or computing device. For example, the data management server 150 may store information at a first location on a first computing device (e.g., a file system, and the like). After a defined duration (e.g., about 1 hour, about 2 hours, about 1 day, and the like) the data management server 150 may move the information from the first location on the first computing device to a second location on a second computing device.

In some cases, a user ID and/or a user key may be used as an indicator of different tiers of access to different data sets. For example, a first user (e.g., a supervisor or manager) may have permissions to access a substantial amount of records and a second user may have permissions to access limited information. In such an example, the second user may have access to publically available information and/or to a smaller data subset (e.g., public records, 10 records, 6 records, 20 records, or other number of records). The data management server 120 may initiate a lockdown procedure if a user engages in unusual behavior (e.g., accessing different data than normal, attempting to download a complete ledger or account information, and the like). For example, unusual behavior may be defined by a specified amount of data, a type of data access (e.g., read only access, read/write access, write access, and the like), and/or a length of time any particular user spent accessing data (e.g., 24 hours, twice an average access time, and/or the like). In some cases, the unusual behavior threshold may be defined on an individual basis, based on a group of similar users, based on a particular data access tier, and/or the like.

In some cases, the data access management system 100 may be configured to monitor communications by one or more users (e.g., a user of the user device 110) over one or more networks external to the business organization, such as one or more social media networks, online public messaging websites, and/or the like. In some cases, the data management server 120 may include a communications monitoring module 180 that may be configured to monitor communications posted or otherwise communicated over the one or more social media networks and/or public messaging websites and/or the like. For example, the communications monitoring module 180 may comprise a data repository storing user identification information, such as a legal name, an online user name, an address, a phone number, a user device identifier (e.g., a MAC address, and the like), a geographic region associated with the user, and/or the like. In some cases, the communications monitoring module 180 may access one or more social networks, online message boards, and/or other similar to identify one or more posts and/or messages associated with at least a portion of the user identification information. In some cases, the communications monitoring module 180 may identify and/or search via the network 115 (e.g., the Internet) for posts or other communications associated with the user identification information that may be shared or posted at a location (e.g., a website, a download location, a file transfer protocol (ftp) site, a data store, and the like) associated with improper financial activity. Such improper financial activity may include selling, or otherwise making available, user identification information, private user information (e.g., usernames, government identification information, account numbers, and the like) and/or private or non-public information accessed from the data repository 134 and/or the business unit computing systems 170, such as via the data envelope 150.

In some cases, the data management module 180 may receive an indication of data accessed through the data envelope 150 (e.g., a data classification, account information, and/or the like). This indication may be used by the data management module to monitor information disseminated via one or more websites and/or social networks to determine whether data that was accessed via the data envelope 150 was improperly provided via the one or more websites and/or social networks. If so, the communication via the security management server 140 may initiate a lockdown procedure to secure communications via the data envelope 150. For example, the security management server may be configured to manage an identified security breach by blocking access and/or revoking access to data, such as via the data envelope 150.

In some cases, the communications monitoring module 180 may monitor indication of user behavior to determine whether a particular user may be intentionally or unintentionally posting sensitive data on social media. The security management server 140 and/or the data management server 120 may be configured to identify and/or to increase a risk level associated with a particular user through data risk analytics to determine whether a user's access to certain information may be more likely. In some cases, the security management server 140 and/or the data management server 120 may utilize a user's credentials or other user identification information to monitor (e.g., “crawl” or the like) web sites and/or social media networks to identify whether the user's credentials and/or other private information is detected on certain outlets (e.g., websites improperly selling private and/or sensitive information of others, websites associated with illicit activity such as those on the “dark” web, and the like) and/or whether the detection of which has now weakened the first level of authentication. In some cases, the security management server 140 and/or the data management server 120 may identify one or more users related to a user identifier (e.g., a “handle”) that may be associated with a person known, or suspected, of participating in improperly accessing and/or disseminating private or sensitive information. The security management server 140 and/or the data management server 120 may associate this user handle to an individual or group of individuals employed at a data facility and then identify the individual or group of individuals as causing the improper dissemination of information.

In some cases, the data management server 120 and/or the security management server may be configured to identify whether improper use of a user's authentication information and/or improper dissemination of private user information has resulted from or is likely to have resulted from some form of user duress. For example, the user device 110 may include one or more biometric sensors (e.g., a temperature sensor, a pulse rate sensor, a surface resistivity sensor, a facial recognition sensor, a camera, a microphone, and the like) that may be used to capture and indication of certain user characteristics such as body temperature, pulse rate, eye movement, voice characteristics, and the like. The data management server 120 and/or the security management server 140 may leverage such biometric and/or other data to revoke or otherwise lockdown access to the organization's stored data. In some cases, such information may be used to create plausible deniability support that may be used in determining an access level for user.

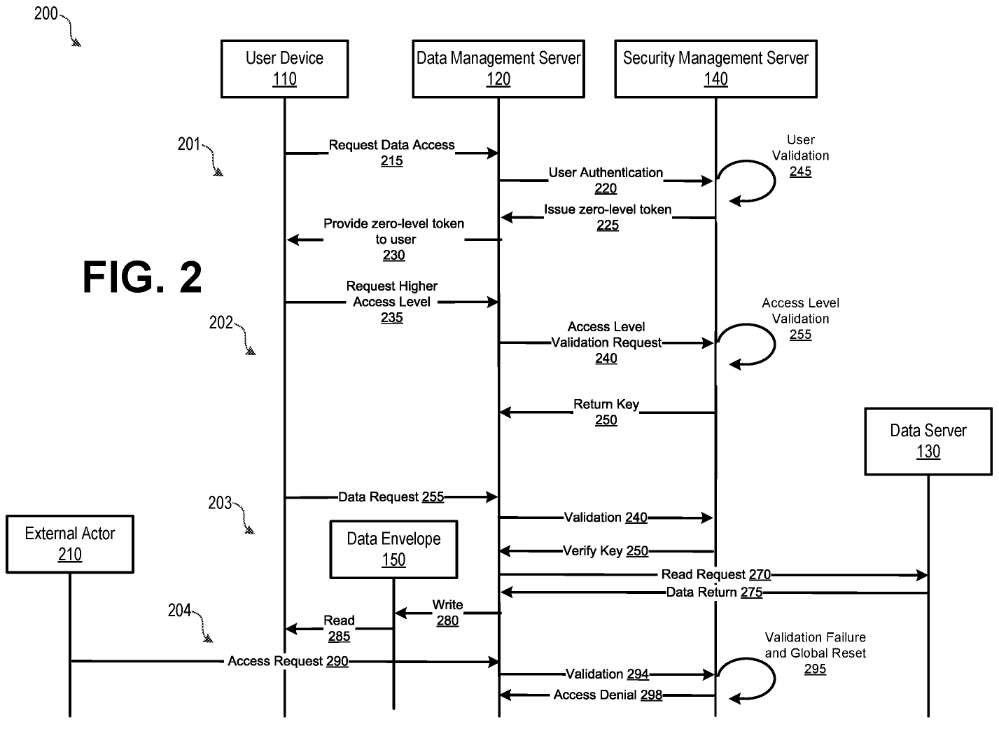

FIG. 2 shows an illustrative event sequence 200 for managing and communicating data via a secure data envelope (e.g., data envelope 150) that includes one or more data containers according to aspects of this disclosure. The illustrative event sequence 200 may include an initial user access request event 201, a user permissions request event 202, a data access event 203 and/or an unauthorized data access event 204.

For example, a user access event 201 may begin as a request for data access 215 being communicated over the network 115 from the user device 110 to the data management server 120. In response to the request for data access 215, the data management server 220 may request user authentication 220 from the security management server 140, upon which the security management server 245 may perform some form of user validation 245 based on user identification information received from the user device 110. In response to the user authentication request 220 after a successful user validation 245, the security management server 140 may issue a zero-level token or key 225 and communicate that zero-level token or key to the data management server 120. The data management server 120 may then communicate, via the network 115, the zero-level token to the user 230 that may be used to access least sensitive data, such as publicly available data or other low-level data.

If a user desires access to more sensitive data, the user may initiate the user permissions request event 202. Here, the user device 110 may communicate the higher access level request 230 to the data management server 120 via the network 115. The data management server may then issue an access level validation request 240 to the security management server 140. In some cases, user identification and/or biometric information may be communicated to the data management server 120 with the higher access level request 230 or in response to a query received from the security management server 140 at the data management server 120. Once the access level validation 255 has completed successfully by the security management server 140, a higher access level key may be communicated 250 from the security management server 140 to the data management serer 120. In some cases, the data management server may manage the access key for the user. In some cases, the data management server 120 may communicate the access key to the user (not shown).

The data access event 203 may include the user device 110 communicating a data access request 255 to the data management server 120 via the network 115. In response to the data access request 255, the data management server 120 may request validation 240 of the user from the security management server 140 using an authorization key (e.g., the zero level token, the higher level access key, and the like) either communicated from the user device with the data access request 255 or stored locally by the data management server 120. If validation was successful and the key was verified 250 by the security management server 140, the data management server 120 may communicate a data read request 270 to the data server 130 to read the requested data from the data repository 134 and/or from one or more of the business unit computing systems 170. The data server 130 may then communicate the data to the data management server 120 at 275. The data management server 120 may then write 280 the requested data to the correct data container of the data envelope 150 based on the key associated with the user and/or the key associated with the data. The data may then be read 285 by the user device 110 at the associated data container.

In some cases, some external actor 210 may attempt to access data 290 via the network 115 via the data management server 120 and/or through the data envelope 150. The data management server 120 may then request validation 294 from the security management server 140. If the user is unknown, using an expired or compromised key or toke, or the like, the security management server 140 may communicate an access denial 298 to the data server, while indicating the validation failure in a report of unauthorized access attempts and may issue a global reset of access keys 295 and otherwise lockdown the data envelope communication.

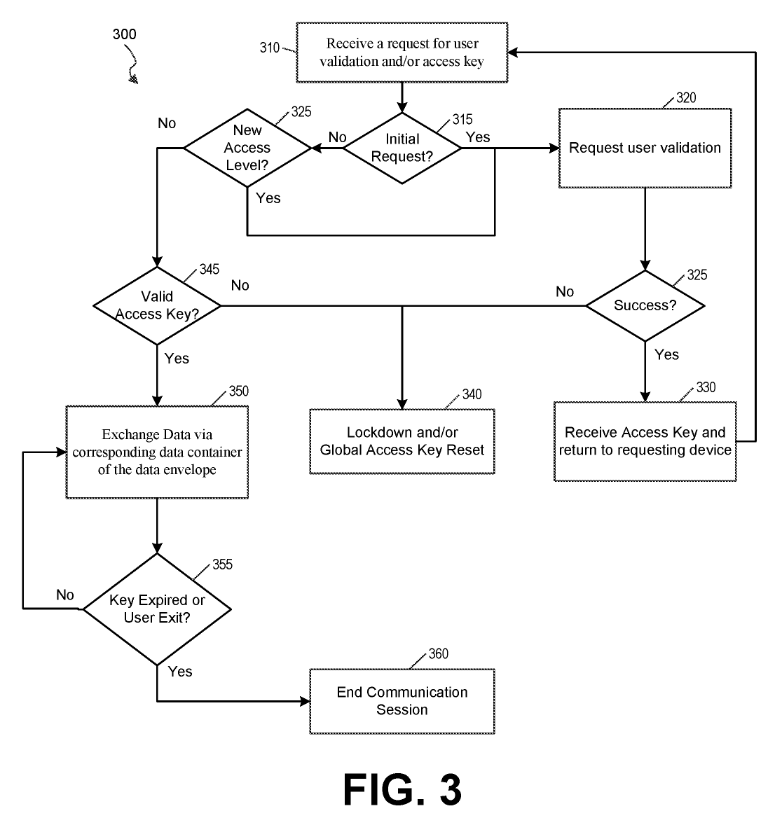

FIG. 3 shows an illustrative method 300 for managing access to data via a secure data envelope 150 that includes one or more data containers in accordance according to aspects of this disclosure. At 310 a device, such as the data management server 120, may receive a request for access to data from a device (e.g., the user device 110, a remote device, and/or the like). The request may include user identification information and/or an access key. In some cases, the request for access may include an initial request for access to network data and may or may not include an authorization key. At 315, the data management server 120 may process the request to determine whether or not the received request is an initial request for access to the data from the remote device. If so, the data management server 120 may communicate the user identification information to the security management server 140 for validation at 320. The security management server 140 may process the user information to validate the user access request to determine whether the user and/or the user device 110 has valid access rights to the data. In some cases, the user information may include a user name, one or more device identifiers associated with the user, user location information, user biometric information, and/or other user identifiers. At 325, the data management server 120 may receive a response to the user validation request from the security management server 140. If the validation was successful, at 330 the data management server may, receive an access key (e.g., a public access key in response to an initial request, a higher level access key in response to data requiring higher access rights, and the like) from the security management server 140 and return the access key to the requesting user device 110 and the data management server 120 may wait for a new request to be received. If the validation was not successful, the security management server may initiate a lockdown procedure at 340 for the data envelope 150 and/or the system, where associated authorization keys or tokens may be subject to a global reset. In some cases, the data management server 150 may perform a global reset of the data access system to force all logged in users to be logged out of the system. In some cases, the data management server may allow currently logged in users to remain until the user logs out or the authorization key expires.

Returning to 315, if the data management server 120 determines that the request is not an initial request, the data management server 120 may process the request to determine whether a new access level request has been received from the user device 110. If so, the data management server 110 may request user validation for the new access rights (e.g., a higher level access right, a request for different information from the organization computing system, and/or the like) at 320. If the request does not include a request for greater access rights at 325, then the data management server may communicate the access key to the security management device 140 to determine whether an access key or token received from the user device 110 is valid. If not, the data management server and/or the security management server may initiate a lockdown and/or a global authorization key reset at 340 in response to an invalid access key. In some cases, the invalid access key may correspond to a valid authorization key being used by a different user, an invalid authorization key, a valid authorization key being received from an unknown user device, a valid authorization key being received from one or more unauthorized geographic locations, and/or the like.

If, at 345, the authorization key is valid, at 350 the data management server may initiate data communication via a corresponding data envelope 150 at the data container having a same access tier as is associated with the authorization key. The data management server 120 may process the data requests received from the user device 110 and relay the request to a data server 130 to retrieve the data from the data repository 134 and/or one or more business unit computing systems 170. The data management server 120 may monitor the communications with respect to the authorization key to determine whether the authorization key has expired at 365. If not, the data management server continues to authorize communication at 350. If the authorization key has expired at 355, such as by meeting a communication limit threshold (e.g., 10 requests, 20 requests, a specified duration, and the like), the data management server 360 may end communication with the user device 110.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A data management server comprising:
a processor; and
a non-transitory memory device storing instructions that, when executed by the processor, cause the data management server to:
receive, via a network connection from a user device associated with a user, a request for access to data stored on an organization's network, the request comprising user authentication information;
upon validation of the user authentication information by a security management server, provide access to data via a secured data container of an electronic data envelope corresponding to the data, wherein the data container corresponds to the validated user authentication information;
monitor, via a network connection, information associated with the user posted on one or more publically accessible information sources for an indication of improper use of secured information associated with the data stored on the organization's network; and
initiate, in response to the indication of improper use, a system data access lockdown process.

2. The data management server of claim 1, wherein the user device is located remotely from the organization's network.

3. The data management server of claim 1, wherein the instructions, when executed by the processor, cause the data management server to:
receive, from a sensor associated with the user device, a signal corresponding to a physical status of the user;
analyze the signal to determine a current physical status of the user; and
upon determining that the current physical status of the user corresponds to an indication of duress, initiate a system data access lockdown process.

4. The data management server of claim 1, wherein the instructions, when executed by the processor, cause the data management server to:
identify, from the received request for access to data stored on the organization's network, whether or not the request is a first request to access the data;
receive, from the security management server upon validation of the first request, an authorization key to data corresponding to a lowest access level tier; and
communicate, to the user device, the received the authorization key.

5. The data management server of claim 1, wherein the instructions, when executed by the processor, cause the data management server to:
receive, from the security management server, an indication that the user authentication information is invalid; and
initiate, in response to the indication that the user authentication information is invalid, a system data access lockdown process.

6. The data management server of claim 5, wherein the system data access lockdown process comprises a global reset of the user authorization keys associated with the data envelope.

7. The data management server of claim 5, wherein the instructions, when executed by the processor, cause the data management server to:
allow users already accessing data via the data envelope continued access to the associated data; and
prevent access to the data from additional users.

8. A system comprising:
A data management server comprising:
a processor; and
a non-transitory memory device storing instructions that, when executed by the processor, cause the data management server to:
receive, via a network connection from a user device, a request for access to data stored on an organization's network, the request for access comprising user authentication information;
upon validation of the user authentication information by a security management server, provide access to data via a secured data container of a data envelope corresponding to the data, wherein the data container corresponds to the validated user authentication information;
monitor, via a network connection, information associated with the user posted on one or more publically accessible information sources for an indication of improper use of secured information associated with the data stored on the organization's network; and
initiate, in response to the indication of improper use, a system data access lockdown process.

9. The system of claim 8, comprising the security management server communicatively coupled to the data management server.

10. The system of claim 8, wherein the user device is located remotely from the organization's network.

11. The system of claim 8, wherein the network connection comprises one of an Internet connection or a telecommunications network.

12. The system of claim 8, wherein the instructions, when executed by the processor, cause the data management server to:
identify, from the received request for access to data stored on the organization's network, whether or not the request is a first request to access the data;
receive, from the security management server upon validation of the first request, an authorization key to data corresponding to a lowest access level tier; and
communicate, to the user device, the received the authorization key.

13. The system of claim 8, wherein the instructions, when executed by the processor, cause the data management server to:
receive, from the security management server, an indication that the user authentication information is invalid; and
initiate, in response to the indication that the user authentication information is invalid, a system data access lockdown process.

14. The system of claim 13, wherein the system data access lockdown process comprises a global reset of the user authorization keys associated with the data envelope.

15. The system of claim 13, wherein the instructions, when executed by the processor, cause the data management server to:
allow users already accessing data via the data envelope continued access to the associated data; and
prevent access to the data from additional users.

16. The system of claim 8, further comprising a data server; and
wherein the instructions, when executed by the processor, cause the data management server to:
receive a request for data access via the data container of the data envelope;
communicate the data request to the data server;
receive a response from the data server; and
communicate, via the data container the response received from the data server.

17. A method comprising:
receiving, at a data management server via a network connection from a user device, a request for access to data stored on an organization's network;
communicating, to a security management server, user authentication information associated with the received request;
upon validation of the user authentication information by the security management server, provide access to data via a secured data container of a data envelope corresponding to the data, wherein the data container corresponds to the validated user authentication information;
monitoring, via a network connection, information associated with the user posted on one or more publically accessible information sources for an indication of improper use of secured information associated with the data stored on the organization's network; and
initiating, in response to the indication of improper use, a system data access lockdown process.

18. The method of claim 17, comprising:
receiving, at the data management server, a request for data access via the data container of the data envelope, wherein the request includes an authentication key;
communicating, upon validation of the authentication key, the data request to a data server;
receiving, at the data management server, a response from the data server; and
communicating, via the data container of the data envelope, the response received from the data server.

19. The method of claim 17, comprising:
identifying, by the security management server based on the received request for access to data stored on the organization's network, whether or not the request is a first request to access the data;
validating, by the security management server, the first request, an authorization key to data corresponding to a lowest access level tier; and
communicating, to the user device, the received the authorization key.

20. The method of claim 17, wherein the data envelope comprises a plurality of data containers, wherein each data containers corresponds to a different access tier including a first access tier corresponding at least a first data access tier comprising a secure level access permissions level and a second access tier level comprising a public level access permissions level.
